(19) United States
(12) Patent Application Publication
(10) Pub. No.: US 2020/0198133 A1
(43) Pub. Date: Jun. 25, 2020

(54) METHOD AND APPARATUS FOR TORQUE ESTIMATION

(71) Applicant: PILZ GMBH & CO. KG, Ostfildern (DE)

(72) Inventors: Knut GRAICHEN, OSTFILDERN (DE); Daniel BAKOVIC, OSTFILDERN (DE); Tobias GOLD, BOEHMENKIRCH (DE); Andreas VOELZ, Neunkirchen Am Brand (DE)

(21) Appl. No.: 16/718,755

(22) Filed: Dec. 18, 2019

(30) Foreign Application Priority Data
Dec. 21, 2018 (DE) 10 2018 133 349.8

(51) Int. Cl. B25J 9/16; G01L 3/14; B25J 13/08

(52) U.S. Cl. CPC B25J 9/1653; B25J 9/1633; G01L 3/14; B25J 9/1641; B25J 13/088; B25J 9/1607; B25J 9/1674

(57) ABSTRACT

A method for estimating a torque acting on a joint of a robot. The method comprises performing an identification routine for determining a position-dependent error rotation angle of a rotational deformation of a transmission. Subsequently, a rotation angle of a rotational deformation of the transmission is measured at a joint position and the measured rotation angle is corrected by means of the identified error rotation angle.

### CROSS-REFERENCE TO RELATED APPLICATION

This application claims priority from German patent application DE 10 2018 133 349.8 filed on Dec. 21, 2018. The entire content of the priority application is incorporated herein by reference.

### BACKGROUND OF THE INVENTION

The present invention relates to methods for estimating the torque acting on a robot joint, and corresponding robots.

Nowadays, essential tasks in industrial production are performed by robots, which are increasingly working autonomously. Nevertheless, it has been shown that the human operator will continue to be an integral part of modern production facilities in the future. Development is therefore increasingly focusing on the area of safe human-robot collaboration, i.e. the creation of an environment in which humans and robots can work together without restriction.

Special attention is paid to safety technology, which must be designed in such a way that there is no danger to people or objects through cooperation with robots or other autonomously working units at any time. To this end, it is important that a robot or autonomous unit “recognizes” the environment and the actors operating in it and can take action at any time to prevent injury to persons or damage to objects.

One way of perceiving its environment is to make a robot sensitive to contact with objects in its environment in order to provide collision protection. For example, a robot can be equipped with torque sensors that can determine a torque acting on the joint of a robot. This enables the robot to register even the smallest external forces and to implement safe collision protection by reducing its speed and thus its kinetic energy to a level that prevents injuries or damage in the event of unexpected contact.

In addition to direct torque measurement, it is also possible to derive and estimate the torque acting on a robot indirectly via other measured variables. For example, the effective torque can be inferred from the motor current. The advantage over direct measurement using torque sensors is that usually existing sensors can be reused or simpler and cheaper sensors can be put to use for determining the measured variables for the derivation. A disadvantage, however, is that estimation and derivation errors must be taken into account when determining a torque from indirect measurement. These are usually more complex and more difficult to determine than measurement errors of a direct measurement.

### SUMMARY OF THE INVENTION

It is an object of the present invention to provide a method for estimating a torque which takes into account the above disadvantages. Furthermore, it is an object to provide a method for estimating a torque that allows a precise and reliable determination of a torque even for critical applications. Yet further, it is an object to provide a precise and reliable determination of a torque based on indirect measurement.

According to a first aspect of the present invention, there is provided a method for estimating a torque acting on a joint of a robot comprising the steps: Providing a drive; connecting the drive to the joint via a transmission; performing an identification routine to determine a position-dependent error rotation angle of a rotational deformation of the transmission; measuring a rotation angle of a rotational deformation of the transmission at a joint position; compensating the measured rotation angle by the identified error rotation angle; and determining a first estimate for the torque at the joint position from the corrected rotation angle.

It is therefore an idea of the present invention to determine external influences, which affect the moment equilibrium of a robot, by means of an estimate. The estimate is based on a rotational deformation of the transmission used.

According to a first aspect of the present invention, this estimate is optimized by compensating systematic measurement errors and transmission-inherent effects. For this purpose, a position-dependent error is determined using a data-based approach in the event that no external influences can be assumed. The position-dependent error is then used to correct the actual measurement. The position-dependent error takes into account a systematic measurement error and interferences of the transmission at certain joint positions and is determined in advance by an identification routine.

For this purpose, the robot is moved in a predetermined manner during the identification routine in order to isolate a measurement error for defined joint positions of the robot. The isolated measurement error can then be used to correct the actual measurement, for example in the form of a lookup table that provides a compensation value for certain positions or poses of the robot.

Correction via a predetermined position-dependent measurement error enables precise and reliable determination of external influences that affect the moment equilibrium of a robot, in particular torque acting externally on a joint, solely via torque estimation based on rotational deformation of the joint transmission. Additional torque sensors can thus be avoided. In addition, it is conceivable that a direct measurement using torque sensors is enhanced by the torque estimation. In this way, redundancy which is often required in safety technology can be achieved or diversity which can effectively rule out errors of common cause can be increased, since different measuring methods are combined to determine the acting torque.

In a preferred refinement, the identification routine can comprise performing a defined movement of the joint.

The identification procedure can thus be a sequential identification procedure with several passes, wherein only one joint of the robot is moved in each pass. In this way, a simplified dynamic model of the robot can be used, which simplifies the isolation of a systematic measurement error. In particular, centripetal effects and Coriolis effects can be effectively excluded if the movement of the individual joint is selected appropriately. This refinement thus contributes to a particularly simple and precise determination of the position-dependent error.

The defined movement can be a movement with a constant speed. In this way, moments of inertia can be neglected, further simplifying the dynamic model of the robot, so that essentially only gravitational moments have to be taken into account.

In a further refinement, a search table can be created during the identification routine, which links position data in a joint space of the joint with error rotation angles.

Using a search table makes it particularly easy and efficient to correct an actual measurement, since a compensation value can be looked up in the search table for each position.

The joint space of the joint is divided into discrete, in particular equidistant, sections to create the search table and each section can be assigned an aggregated error rotation angle from the identified error rotation angles. This interpolation can enable an efficient correction even under real-time conditions.

The corrected rotation angle in a section can be the measured rotation angle minus the aggregated error rotation angle in that section. Correction can therefore be achieved by a simple subtraction.

In a further refinement, a tuple can be determined during the identification in a defined interval, the tuple comprising measured values for a current position, speed of the joint, and a rotation angle of the rotational deformation of the transmission at the current position, wherein for each tuple an error rotation angle at the current position can be determined from the measured values. In this way, the identification routine can be performed particularly efficiently and quickly.

In a further refinement, the transmission can have a position sensor on both the input and output side to measure the rotation angle of the rotational deformation of the transmission.

Using a position sensor on the input side and on the output side of the transmission enables an easy determination of a rotational deformation of the transmission by determining an offset of the position sensors. The refinement using position sensors can be implemented cost-effectively and thus contributes to a cost-effective design of the estimation procedure.

In a preferred refinement, the transmission is a strain wave gear with an elastic transmission element.

Strain wave gears allow a particularly good estimation of the torque via rotational deformation of the transmission, since the elastic transmission element makes rotational deformation of the transmission more pronounced and therefore easier to measure.

According to another aspect of the present invention, there is provided a method for estimating a torque acting on a robot joint comprising the steps: Providing a drive; connecting the drive to the joint via a transmission; measuring a rotation angle of rotational deformation of the transmission at a joint position; measuring a motor current of the drive at the joint position; determining a first estimate of torque at the joint position from the measured rotation angle; determining a second estimate of torque at the joint position based on the measured motor current; and merging the first estimate and the second estimate into a consolidated estimate of torque at the joint position.

As an alternative or as a supplement, the object can also be solved by merging two indirect measurements. Thus, on the one hand, a torque estimation can be performed via the motor current and on the other hand, a torque estimation via the rotational deformation can be performed simultaneously, wherein the results of both estimates are subsequently combined.

In this way, external influences acting on the robot's torque equilibrium can also be precisely and reliably determined without additional torque sensors. Merging has the advantage that known properties of the respective estimation methods can be taken into account, so that a more precise result can be achieved than with a single estimation only. Similarly, the merging of two indirect measurements can achieve a redundancy that is often required in safety technology and can increase diversity, since different measurement methods are used.

In a preferred refinement, merging is performed with a constant weighting or with time-variant weights.

By weighting, merging can be adapted to different properties of the estimation methods to be merged. Thus, the estimation can be further optimized.

It goes without saying that the features mentioned above and the features to be explained below can be used not only in the combination indicated, but also in other combinations or uniquely, without leaving the scope of this invention.

### BRIEF DESCRIPTION OF THE DRAWINGS

Exemplary embodiments of the invention are shown in the drawings and are explained in more detail in the following description. In the drawings:

FIG. 1 shows a schematic representation of a robot according to an embodiment of the present invention,

FIG. 2 shows a flow chart of a method according to a first aspect of the present invention,

FIG. 3 shows a flowchart of a method according to a second aspect of the present invention, and

FIG. 4 shows a schematic representation of a preferred exemplary embodiment of torque estimation.

### DETAILED DESCRIPTION OF THE PREFERRED EMBODIMENTS

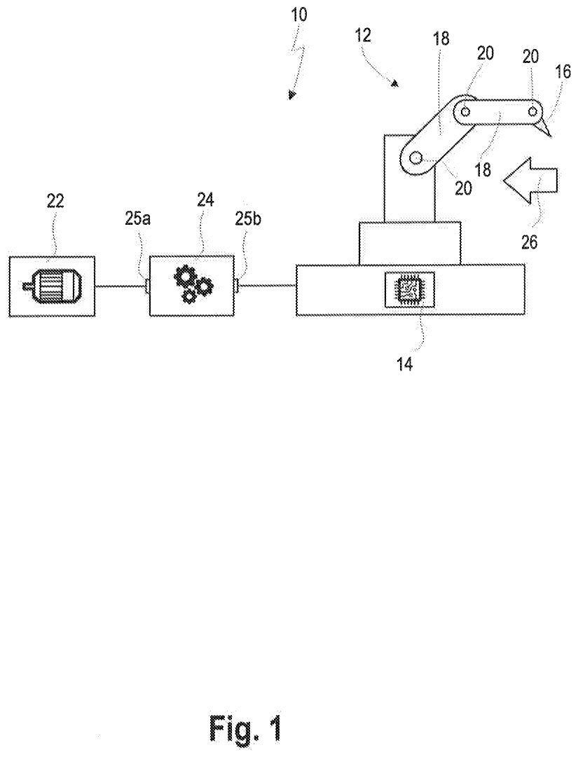

In FIG. 1, a robot according to an exemplary embodiment of the invention is denoted in its entirety with the reference numeral 10.

In this exemplar embodiment, the robot 10 is an industrial robot. Industrial robots are universal, programmable machines for handling, assembling or processing work pieces. An industrial robot comprises a manipulator 12 (robot arm), a controller 14 and an effector 16, which can be designed as a tool or gripper.

The manipulator 12 shown in FIG. 1, for example, has two links 18 and three joints 20. However, it goes without saying that the invention is not limited to the number of links and joints shown here. Rather, the methods presented here can be applied to a plurality of individual joints.

The links 18 of the manipulator 12 are moved via the joints 20 and are driven by a drive 22, which is connected to the robot 10 via a transmission 24. The transmission 24 and the drive 22 are shown separately from the manipulator 12 for the sake of clarity. However, drive 22 and transmission 24 can be integrated into the manipulator 12, especially into the joints 20. Furthermore, a separate drive 22 and a separate transmission 24 can be provided for each joint 20.

The controller 14 controls the drive(s) 22 of the manipulator 12 so that it executes a movement desired by the user. The controller 14 can be a programmable controller, i.e. work sequences and movement sequences can be stored as programs which are executed autonomously by the controller 14.

Via an external or integrated sensor system, additional sensor information can be recorded by the controller 14 which influences the work sequence or movement sequence of the manipulator 12. Usually a position sensor 25a can be provided on the drive side, which can be used to determine a joint position. On the drive side, this means that the position sensor is located in front of the transmission, i.e. on the motor side. In addition, a position sensor 25b can also be provided on the output side, i.e. a position sensor which is located downstream of the transmission and between the transmission and the joint. Such a sensor is also referred to as a joint side position sensor. Via a position sensor on the input and output side, a rotation angle of a rotational deformation of the transmission 24 can be easily determined by an offset between the sensors.

The controller 14 also executes procedures that can be used to determine external influences that affect the moment equilibrium of the robot 10. In particular, this can be an external force 26 acting on the robot and resulting in a corresponding torque on the joint 20 of the manipulator 12.

The determination of the external torque 26 makes it possible to register even small acting forces when the robot 10 touches persons or objects. In this way, in the event of a collision with an obstacle, for example a contact with a human being, the robot 10 can be enabled to carry out appropriate control functions via the controller 14, which cause the robot to move back or stop moving.

An estimation method is a method in which the torque is not determined by a direct measurement using torque sensors, but is derived from another measured variable. In particular, the measured variables can be recorded by sensors that are standard on an industrial robot. These sensors can be, inter alia, position sensors or current meter which can be used to directly or indirectly determine relevant measured variables.

In the present disclosure, two methods of torque estimation are considered. The first method involves torque estimation via the motor current and the second method torque estimation via torsional deformation of the transmission.

To determine the associated measured variable, a current meter can be provided for the first method, which measures a current to the drive. The rotational deformation of the transmission 24 can be determined via position sensors 25a, 25b on the drive side of the transmission and on the output side of the transmission 24. Via the relative offset of the drive side and the output side a rotation angle can be determined which, like the motor current, has a defined, modelable relationship to the effective torque 26. Such an offset is usually larger for a strain wave gear than with other transmissions due to the elastic element. Nevertheless, a high measuring accuracy of the position sensors is still important.

Due to the large transmission ratio N of the transmission, the position resolution of the motor-side position sensor is N times higher than the resolution of the joint. The resolution for the measured rotation angle is thus limited by the resolution on the joint side. It is not unusual that the resolution is in the same order of magnitude as the expected torsional deformation. Accordingly, the influence of a systematic error in the position measurement is large on the angle measurement. The determination of the effective torque from the rotation angle must therefore be optimized in order to compensate for this effect.

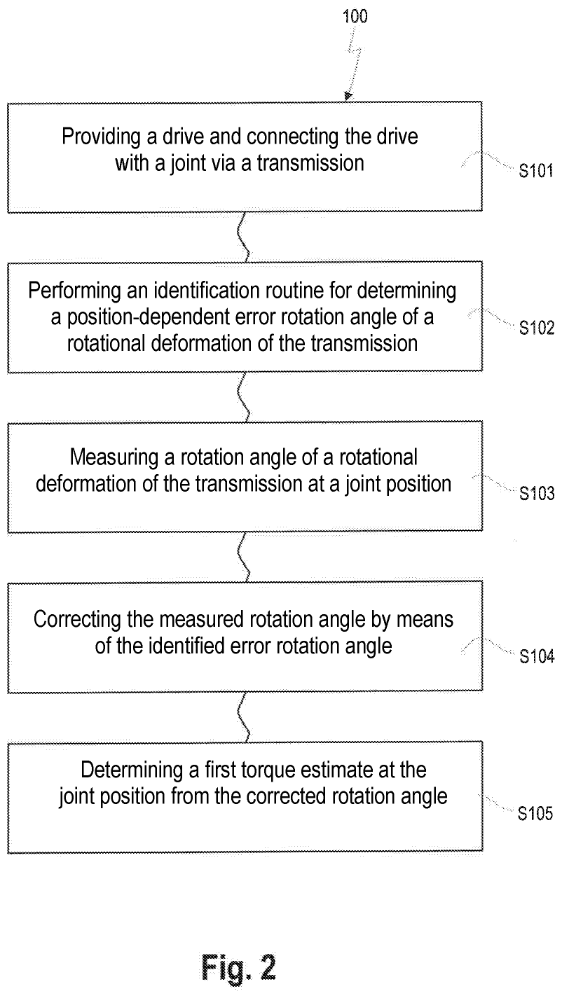

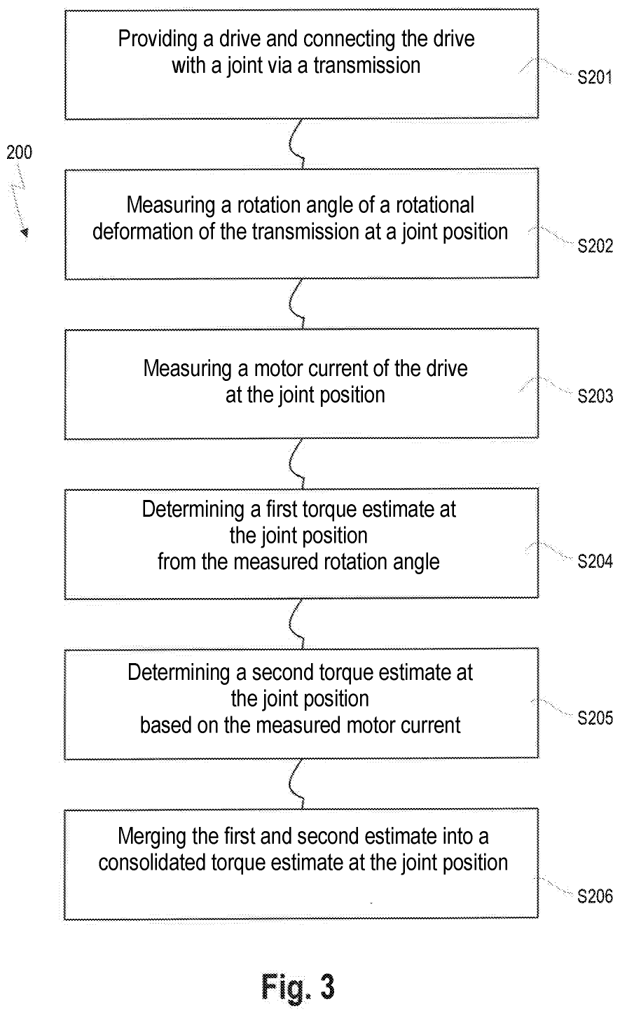

In order to optimize the estimation, the methods described below can be performed individually or in a complementary manner. FIG. 2 shows in a flowchart a method 100 which optimizes an estimate based on a rotational deformation, and FIG. 3 shows a method 200 which combines two estimation methods. Same reference signs designate same parts as in FIG. 1.

In method 100 according to FIG. 2, in a first step S101 a drive 22 of the robot 10 is provided and connected via a transmission 24 to at least one joint 20 of the robot 10.

Subsequently, an identification routine is performed in step S102.

The identification routine includes defined control of the robot 10 in a state in which certain external influences affecting the moment equilibrium of the robot 10 can be excluded, i.e. the robot can move in the working area free of obstacles.

The aim of the identification routine is to determine a characteristic curve that describes position-dependent errors which correspond to systematic measurement errors and position-dependent interference effects of the transmission 24.

By controlling the robot in a defined way during the identification routine, a simplified dynamic model of the robot can be assumed, which can be used to determine the position-dependent error in the form of a location-dependent error rotation angle. The identification routine can be executed sequentially, whereby only one link of the robot is moved in each pass. Thereby, centrifugal effects and Coriolis effects can be excluded.

Furthermore, the defined control can be a movement with constant speed, whereby moments of inertia can be neglected.

The defined control makes it possible to describe the movement of the robot using a simplified dynamic model.

In general, an industrial robot can be described by a motion differential equation system:

M(q)\ddot{q}+C(q, \dot{q})\dot{q}+g(q)+τₑₓₜ=τ_{J}

M is the mass inertia matrix, C represents the vector of the generalized constraint moments caused by centripetal forces and Coriolis forces in the joints, and g represents the vector of the generalized gravitational moments. τ_{J} describes the torque transmitted by the transmission, which results from the motor torque minus the friction moments of the motor and the transmission. q(t) represents the vector of the motion coordinates of the axes and τₑₓₜ describes the external influences which affect the moment equilibrium and which are to be determined.

The defined control allows individual terms of this equation, in particular the mass moments of inertia and force moments, to be removed from the model, so that essentially only gravitational moments have to be taken into account.

During the identification routine, tuples of measured values are recorded, preferably at intervals, each containing a current position and speed of the joint and a rotation angle of the rotational deformation of the transmission at the current position.

Using the simplified dynamic model, an error can then be assigned to each tuple, resulting in a search table that links position data in a joint space of the joint to error rotation angles. The joint space of the joint can be subdivided into discrete, in particular equidistant, sections and each section can be assigned an aggregated error rotation angle from the error rotation angles.

The data obtained from the identification routine, in particular the search table, can be stored in the controller 14 of the robot 10 or an associated memory and can be used for compensation.

It goes without saying that the identification routine must be performed at least once before an actual measurement is performed in order to determine the corresponding data. In addition, the identification routine can also be repeated at each system start or in defined cycles to update the position-dependent error values.

Step S103 denotes an actual measurement process in which a rotation angle of a rotational deformation of the transmission is measured at a joint position.

The measured rotation angle is then corrected in step S104 using the data determined during the identification routine. An error rotation angle at the given position can be determined from the data and subtracted from the measured rotation angle in order to obtain a corrected rotation angle.

In step S105, an estimate for the effective torque is then determined from the corrected rotation angle using a known relationship between rotation angle and effective torque.

The known relationship between rotation angle and effective torque can be modelled, for example, by a cubic curve of the following form:

Here, k_{l,j} stands for the linear stiffness and k_{c,j} stands for the cubic stiffness of the j-th link. It goes without saying that the method is not limited to this model, but that other models of the relationship can also be considered.

The torque determined according to the method described in FIG. 2 is considerably more accurate than an estimate without error compensation, especially when using transmissions with a large gear reduction.

Alternatively or in addition to the methods explained in relation to FIG. 2, a moment estimate can also be made more precise by a merging two indirect measurements, as shown below with reference to FIG. 3.

FIG. 3 shows in a flowchart an alternative method for estimating the moment according to an aspect of the present invention.

In the alternative method, torque estimation is optimized by performing two independent estimates and merging their results into an overall result.

As with the method above, in step S201, a drive 22 is provided and connected to the joint 20 of the robot 10 via a transmission 24. Subsequently, the two independent estimates are made by recording the relevant measurement values.

In step S202, a rotation angle of a rotational deformation of the transmission is measured at a joint position. This is can be done by position sensors on the input and output side, wherein the mutual offset of the sensors results in a rotation angle that is representative of the rotational deformation of the transmission 24.

In step S203, the motor current of the drive is also measured at this joint position. The motor current can be measured simultaneously.

Then, in steps S204 and S205, independent estimates for the effective torque are made.

In step S204, a first estimate of the torque at the joint position is determined from the measured rotation angle. In step S205, a second estimate of the torque at the joint position is determined based on the measured motor current.

Finally, in step S206, the first and second estimates are merged into a consolidated estimate for the torque at the joint position. The aim of performing the merging is to obtain a better overall result for estimating torque by combining the individual estimates.

Merging can be performed with constant weighting or with time-varying weights.

In the first approach, merging is based on probability theory. For this purpose, the estimates are modelled as probability densities with the means μₜ=\hat{τ}_{ext,t} and μₘ=\hat{τ}_{ext,m} with the estimation variants σₜ² and σₘ². The distributions, if no τₑₓₜ is present, are medium-free for μₜ=μₘ≈0.

If the probability density is approximated by a Gaussian distribution, the parameters of the conditional Gaussian probability can be determined under consideration of the two individual estimation probabilities according to the Bayesian rule as

$${\hat{𝒯}}_{ext . f} = \frac{{σ}_{m}^{2}}{{σ}_{t}^{2} + {σ}_{m}^{2}} {μ}_{t} + \frac{{σ}_{t}^{2}}{{σ}_{t}^{2} + {σ}_{m}^{2}} {μ}_{m}$$

$$and$$

$${\hat{σ}}_{ext , f}^{2} = \frac{{σ}_{t}^{2} {σ}_{m}^{2}}{{σ}_{t}^{2} + {σ}_{m}^{2}} < {σ}_{t}^{2} , {σ}_{m}^{2} .$$

As a result, by using both estimates, the variance is smaller than the lowest individual variance and the consolidated estimate thus leads to a better overall result.

The second approach involves merging with time-varying weights. The idea here is to prefer the individual estimate which is closer to the expectation of an external moment of 0. Accordingly, the deviation for the weighting of the individual estimates is changed to the squared estimated external moment.

This leads to a formulation of the form

$${\hat{𝒯}}_{ext , f}^{2} = \frac{{\hat{𝒯}}_{ext , m}^{2}}{{\hat{𝒯}}_{ext , t}^{2} + {\hat{𝒯}}_{ext , m}^{2}} {\hat{𝒯}}_{ext , t} + \frac{{\hat{𝒯}}_{ext , t}^{2}}{{\hat{𝒯}}_{ext , t}^{2} + {\hat{𝒯}}_{ext , m}^{2}} {\hat{𝒯}}_{ext , m} ,$$

i.e. the weights are inversely proportional to the corresponding square distance.

This reduces the variance, as estimates close to 0 are preferred. As a result, if, for example, only one estimate increases, the other estimate, which is closer to 0, dominates the overall estimate. However, if both individual estimates increase, for example due to an external moment, the overall estimate also increases.

Based on the weighted sum of both estimates, the merged estimate always lies between the two individual estimates, but with a tendency to an estimate that is closer to 0.

It goes without saying that merging is not limited to the two approaches mentioned above. As a further approach, for example, weighting by speed could be considered, with torsional moment being preferred at lower speeds and the moment determined by current at higher speeds.

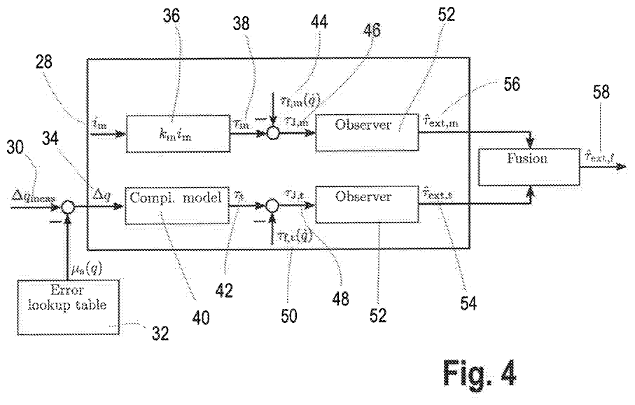

Finally, FIG. 4 shows a preferred exemplary embodiment in which the two methods described above are combined.

In the exemplary embodiment of FIG. 4, on the one hand, an optimized estimation of the rotational deformation of the transmission is performed using compensation based on a previously determined position-dependent error. On the other hand, the estimated torque is simultaneously merged with a torque estimate based on the motor current.

In FIG. 4, the torque estimation using the motor current is indicated above the dotted line and the torque estimation using the optimized estimation based on the rotational deformation of the transmission is indicated below the dotted line.

The measured variables at the input are thus the motor current 28 and the measured rotation angle 30. The measured rotation angle is corrected via a search table 32, as described in detail above with reference to FIG. 2. The result of the correction is a corrected rotation angle 34.

A motor torque 38 is then determined on the basis of a motor current model 36. Further, a torsional moment 42 is determined via the corrected rotation angle 34 and a torsional deformation model 40 of the transmission 24.

Using a first friction model 44, both the engine friction and the transmission friction are then taken into account, which, for example, can be expressed in the form of

τ_{f,m}(\dot{q})=C_{c,m}sgn(\dot{q})+C_{v,m}\dot{q}

C_{c,m}sgn(\dot{q}) represents the Coulomb friction and C_{v,m}\dot{q} the viscous friction of the transmission. Taking both friction components into account, the actual transmitted torque 46 can be determined from the motor torque. It goes without saying that the method is not limited to the friction model shown here, but that other models can also be considered.

Similarly, the transmitted torsional moment 48 can be determined from the torsional moment 42 minus the transmission friction, which can be determined using a second friction model 50. The second friction model 50 can, for example, only include the transmission friction: τ_{f,t}(\dot{q})=c_{v,t}\dot{q}. Here, too, other models of friction are conceivable.

From the transmitted motor torque 46 and the transmitted torsional torque 48, a first estimate 54 and a second estimate 56 for the external torque 26 at the current position can then be determined in a manner known per se.

While this determination is possible on the one hand directly via the dynamic model of the robot, it makes sense to determine the values indirectly via a disturbance observer, since neither the acceleration has to be measured directly nor the inverse mass inertia matrix has to be calculated. The calculation can thus be simplified.

Finally, the first and second estimates 54, 56 are merged into a consolidated estimate 58. Merging may take place in the manner explained with reference to FIG. 3 and may include the different merging approaches.

What is claimed is:

1. A method for estimating a torque acting on a joint of a robot including a drive that is connected to the joint via a transmission, the method comprising the steps of:
performing an identification routine for determining a position-dependent error rotation angle of a rotational deformation of the transmission;
measuring a rotation angle of a rotational deformation of the transmission at a joint position;
correcting the measured rotation angle by means of the identified error rotation angle; and
determining a first estimate for the torque at the joint position from the corrected rotation angle.

2. The method according to claim 1, wherein the identification routine comprises performing a defined movement of the joint.

3. The method according to claim 2, wherein the defined movement is a movement at a constant speed.

4. The method according to claim 1, wherein during the identification routine a search table is created which links position data in a joint space of the joint with identified error rotation angles.

5. The method according to claim 4, wherein, in order to create the search table, the joint space of the joint is subdivided into discrete, equidistant, sections and each section is assigned an aggregated error rotation angle from the identified error rotation angles.

6. The method according to claim 5, wherein the corrected rotation angle in a section is the measured rotation angle of the aggregated error rotation angle in that section.

7. The method according to claim 1, wherein during the identification routine in a defined interval, a tuple is determined which respectively comprises measured values for a current position, speed of the joint, and a rotation angle of the rotational deformation of the transmission at the current position, wherein for each tuple an error rotation angle at the current position is determined from the measured values.

8. The method according to claim 1, wherein the transmission has an input side and an output side, and wherein for measuring the rotation angle of the rotational deformation of the transmission, the transmission comprises a position sensor at the input side and at the output side.

9. The method according to claim 1, wherein the transmission is a strain wave gear having an elastic transmission member.

10. The method according to claim 1, further comprising the steps of:
measuring a motor current of the drive at the joint position;
determining a second estimate for the torque at the joint position based on the measured motor current; and
merging the first and second estimates into a consolidated torque estimate at the joint position.

11. A method for estimating a torque acting on a joint of a robot including a drive that is connected to the joint via a transmission, the method comprising the steps of:
measuring a rotation angle of a rotational deformation of the transmission at a joint position;
measuring a motor current of the drive at the joint position;
determining a first estimate for the torque at the joint position from the measured rotation angle;
determining a second estimate for the torque at the joint position based on the measured motor current; and
merging the first and second estimates into a consolidated torque estimate at the joint position.

12. The method according to claim 10, wherein the merging is performed with constant weighting.

13. The method according to claim 10, wherein the merging is performed with time-varying weights.

14. A non-transitory computer readable storage medium encoded with a computer program which, when executed by a computer processor associated with the robot, causes the computer to execute the method according to claim 11.

15. A robot comprising:
a joint, a drive, a transmission for connecting the drive to the joint, and a controller for estimating a torque acting on the joint;
wherein the controller is configured to perform an identification routine for determining a position-dependent error rotation angle of a rotational deformation of the transmission, measure a rotation angle of a rotational deformation of the transmission at a joint position, correct the measured rotation angle by means of the identified error rotation angle, and determine a first estimate for the torque at the joint position from the corrected rotation angle.

16. A robot comprising:
a joint, a drive, a transmission for connecting the drive to the joint, and a controller for estimating a torque acting on the joint;
wherein the controller is configured to measure a rotation angle of a rotational deformation of the transmission at a joint position, measure a motor current of the drive at the joint position, determine a first estimate for the torque at the joint position from the measured rotation angle, determine a second estimate for the torque at the joint position based on the measured motor current, and merge the first and second estimates into a consolidated torque estimate at the joint position.
